(19) United States
(12) Patent Application Publication
(10) Pub. No.: US 2025/0124386 A1
(43) Pub. Date: Apr. 17, 2025

(54) LEARNING DEVICE, LEARNING SYSTEM, PROPOSAL DETERMINATION DEVICE, LEARNING METHOD, AND RECORDING MEDIUM

(71) Applicant: NEC Corporation, Minato-ku, Tokyo (JP)

(72) Inventors: Ryota HIGA, Tokyo (JP); Shinji NAKADAI, Tokyo (JP); Katsuhide FUJITA, Tokyo (JP); Toki TAKAHASHI, Tokyo (JP)

(73) Assignee: NEC Corporation, Minato-ku, Tokyo (JP)

(21) Appl. No.: 18/686,485

(22) PCT Filed: Aug. 30, 2022
(86) PCT No.: PCT/JP2022/032551

§ 371 Date: Feb. 26, 2024

(30) Foreign Application Priority Data
Aug. 31, 2021 (JP) 2021-141626

(51) Int. Cl. G06Q 10/0637

(52) U.S. Cl. CPC G06Q 10/0637

(57) ABSTRACT

A learning device acquires history information about a proposal which has been implemented in a negotiation, acquires an evaluation value for a proposal from a negotiation counterpart, and learns a determination method for an own proposal to the negotiation counterpart, based on the history information and the evaluation value.

### TECHNICAL FIELD

The present disclosure relates to a learning device, a learning system, a proposal determination device, a learning method, and a recording medium.

### BACKGROUND ART

Several techniques have been proposed for performing automated negotiation. As an example, the order-receiving-side negotiation device disclosed in Patent Document 1 determines a candidate for negotiation regarding an order proposal from a plurality of candidates, based on the utility value of the order-receiving side for the negotiation candidate and the estimated value of the utility value of the order-origin for the negotiation candidate.

### PRIOR ART DOCUMENTS

### Patent Documents

Patent Document 1: PCT International Publication No. WO 2021/033302

### SUMMARY OF THE INVENTION

### Problems to be Solved by the Invention

It is preferable that automated negotiations can be performed even if the counterpart's utility function or utility value, or strategy is unknown.

An example object of the present disclosure is to provide a learning device, a learning system, a proposal determination device, a learning method, and a recording medium capable of solving the problems mentioned above.

### Means for Solving the Problem

According to a first example aspect of the present disclosure, a learning device includes: a history information acquisition means that acquires history information about a proposal which has been implemented in a negotiation; an evaluation value acquisition means that acquires an evaluation value for a proposal from a negotiation counterpart; and a learning means that learns a determination method for an own proposal to the negotiation counterpart, based on the history information and the evaluation value.

According to a second example aspect of the present disclosure, a learning system includes: a history information acquisition means that acquires history information about a proposal which has been implemented in a negotiation; an evaluation value acquisition means that acquires an evaluation value for a proposal from a negotiation counterpart; a learning means that learns a determination method for an own proposal to the negotiation counterpart, based on the history information and the evaluation value, and that outputs its own proposal to the negotiation counterpart based on the determination method; a counterpart model execution means that, upon receiving an input of its own proposal to the negotiation counterpart, outputs a proposal from the negotiation counterpart; and an evaluation means that, upon receiving an input of a proposal from the negotiation counterpart, outputs the evaluation value.

According to a third example aspect of the present disclosure, a proposal determination device includes: a history information acquisition means that acquires history information about a proposal which has been implemented in a negotiation; and a proposal output means that inputs history information acquired by the history information acquisition means into an own action model that has been trained based on the history information of proposals made in negotiations and evaluation values of proposals from a negotiation counterpart, and that acquires and outputs an own proposal to the negotiation counterpart.

According to a fourth example aspect of the present disclosure, a learning method is executed by computer and includes: acquiring history information about a proposal which has been implemented in a negotiation; acquiring an evaluation value for a proposal from a negotiation counterpart; and learning a determination method for an own proposal to the negotiation counterpart, based on the history information and the evaluation value.

According to a fifth example aspect of the present disclosure, a recording medium stores a program that causes a computer to execute: acquiring history information about a proposal which has been implemented in a negotiation; acquiring an evaluation value for a proposal from a negotiation counterpart; and learning a determination method for an own proposal to the negotiation counterpart, based on the history information and the evaluation value.

### Effect of Invention

According to the present disclosure, automated negotiations can be performed even if the counterpart's utility function or utility value, or strategy is unknown.

### BRIEF DESCRIPTION OF THE DRAWINGS

FIG. 1 is a diagram showing a configuration example of a learning system according to an example embodiment.

FIG. 2 is a diagram showing a configuration example of a learning device according to the example embodiment.

FIG. 3 is a diagram showing a configuration example of a data generation device according to the example embodiment.

FIG. 4 is a diagram showing an example of data input/output in the learning system according to the example embodiment.

FIG. 5 is a diagram showing an example of an own action model in a case of using a neural network in the example embodiment.

FIG. 6 is a diagram showing a configuration example of a proposal determination device according to the example embodiment.

FIG. 7 is a diagram showing an example of data input/output in the proposal determination device according to the example embodiment.

FIG. 8 is a diagram showing a configuration example of a negotiation device that pre-reads the action of a negotiation counterpart.

FIG. 9 is a diagram showing an example of a learning system according to a modified example of the example embodiment.

FIG. 10 is a diagram showing characteristics of domains used in an experiment according to the example embodiment.

FIG. 11 is a diagram showing an example of the degree of conflict.

FIG. 12 is a diagram showing evaluation index values of the experiment results according to the example embodiment.

FIG. 13 is a diagram showing an example of a negotiation process within the learning system according to the example embodiment when the negotiation counterpart is a time-dependent agent.

FIG. 14 is a diagram showing an example of variation in the own utility values according to the example embodiment when the negotiation counterpart is a time-dependent agent.

FIG. 15 is a diagram showing an example of variation in the counterpart's utility value according to the example embodiment when the negotiation counterpart is a time-dependent agent.

FIG. 16 is a diagram showing an example of a negotiation process within the learning system according to the example embodiment when the negotiation counterpart is an action-dependent agent.

FIG. 17 is a diagram showing an example of variation in the own utility values according to the example embodiment when the negotiation counterpart is a time-dependent agent.

FIG. 18 is a diagram showing an example of variation in the counterpart's utility value according to the example embodiment when the negotiation counterpart is a time-dependent agent.

FIG. 19 is a diagram showing a configuration example of a learning device according to the example embodiment.

FIG. 20 is a diagram showing a configuration example of a learning system according to an example embodiment.

FIG. 21 is a diagram showing a configuration example of the proposal determination device according to the example embodiment.

FIG. 22 is a diagram showing an example of a processing procedure in a learning method according to the example embodiment.

FIG. 23 is a schematic block diagram showing a configuration example of a computer according to at least one example embodiment.

### EXAMPLE EMBODIMENT

Hereinafter, an example embodiment of the present disclosure will be described, however, the present invention within the scope of the claims is not limited by the following example embodiment. Furthermore, not all the combinations of features described in the example embodiment are essential for the solving means of the invention.

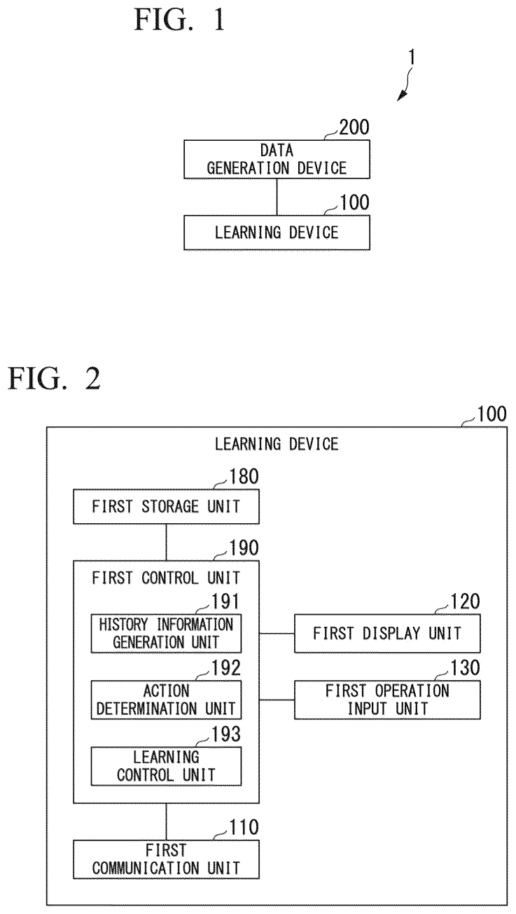

FIG. 1 is a diagram showing a configuration example of a learning system according to the example embodiment. In the configuration shown in FIG. 1, a learning system 1 includes a learning device 100 and a data generation device 200.

The learning system 1 is a system for learning an action determination method in automated negotiations.

The learning device 100 includes a model for determining an action in automated negotiation. The learning device 100 learns the action determination method by updating the parameter values of this model.

The learning device 100 is considered to be the entity engaging in automated negotiation, and may be referred to as “own” or “self”. The action determined by the learning device 100 corresponds to an action of the user of the learning device 100. The action determined by the learning device 100 may also be referred to as own action. Information indicating an own action may also be referred to as own action information. A model for determining an own action may also be referred to as an own action model.

The learning device 100 is configured, using a computer, for example. Alternatively, the learning device 100 may be configured, using hardware designed exclusively for the learning device 100, such as an ASIC (Application Specific Integrated Circuit) or an FPGA (Field Programmable Gate Array).

The data generation device 200 generates data that the learning device 100 uses to learn the action determination method. In particular, the data generation device 200 includes a model that simulates the action of a negotiation counterpart, determines the action of the negotiation counterpart in response to the action determined by the learning device 100, and outputs information indicating the determined action of the negotiation counterpart to the learning device 100. The action of the negotiation counterpart may also be referred to as counterpart's action. Information indicating a counterpart's action may also be referred to as counterpart's action information.

Moreover, the data generation device 200 calculates a utility value indicating the evaluation of the counterpart's action when the learning device 100 determines an action. The utility value for the counterpart's action when the learning device 100 determines the action corresponds to the utility value for the user of the learning device 100. The utility value for the counterpart's action when the learning device 100 determines an action may also be referred to as own utility value.

It should be noted that among the actions in negotiation, “proposal”, which will be described later, is subject to the evaluation based on a utility value.

The data generation device 200 is configured, using a computer, for example. Alternatively, the data generation device 200 may be configured using hardware designed exclusively for the data generation device 200, such as an ASIC or FPGA.

The learning device 100 and the data generating device 200 may be implemented in one computer, that is to say, may be configured as one device.

FIG. 2 is a diagram showing a configuration example of the learning device 100. In the configuration shown in FIG. 2, the learning device 100 includes a first communication unit 110, a first display unit 120, a first operation input unit 130, a first storage unit 180, and a first control unit 190. The first control unit 190 includes a history information generation unit 191, an action determination unit 192, and a learning control unit 193.

The first communication unit 110 communicates with other devices. For example, the first communication unit 110 communicates with the data generation device 200, transmits own action information to the data generation device 200, and receives counterpart's action information and own utility values from the data generation device 200.

The first display unit 120 includes a display screen such as a liquid crystal panel or an LED (Light Emitting Diode) panel, and displays various types of images. For example, the first display unit 120 may display negotiation progress information, such as own action information and counterpart's action information.

The first operation input unit 130 includes input devices such as a keyboard and a mouse, and receives user operations. For example, the first operation input unit 130 may receive a user operation that instructs to start learning the action determination method.

The first storage unit 180 stores various types of data. For example, the first storage unit 180 stores history information about proposals which have been implemented in negotiations. This history information is used as an input to the own action model. Moreover, when the own action model is implemented as software, the first storage unit 180 stores software representing the own action model. The first storage unit 180 is configured using a storage device included in the learning device 100.

The first control unit 190 controls each unit of the learning device 100 and executes various processes. Functions of the first control unit 190 are executed by a CPU (Central Processing Unit) included in the learning device 100 reading out a program from the first storage unit 180 and executing the program.

The history information generation unit 191 stores history information about proposals which have been implemented in negotiations. (The history information will be described later with reference to Expression (1).)

Here, time is represented in time steps, denoted as time 0, time 1, and so forth where the amount of time required for the learning device 100 to determine an own action and the data generation device 200 to determine the counterpart's action in response to the own action is considered as 1 time step. Here, the operation start time of the learning system 1 is set to time 0.

Moreover, it is assumed that an action in negotiation is any one of “proposal”, “acceptance”, and “rejection”. “Proposal” presents (proposes) the specific details of a transaction. Making an own proposal in response to a proposal from the counterpart is also referred to as making a “counter proposal.” “Acceptance” means accepting the counterpart's proposal and ending the negotiation. “Rejection” means rejecting the counterpart's proposal and ending the negotiation. For example, in a case where a negotiation is to be continued until a time limit is reached, only either proposal or acceptance may be determined as an action in negotiation.

Information indicating the specific details of a transaction presented in a proposal is also referred to as proposal information or simply a proposal.

A proposal in which the own action is the proposal is also referred to as an own proposal. A proposal in which the counterpart's action is the proposal is also referred to as a counterpart's proposal.

Where an own proposal at time i is expressed as; and the counterpart's proposal at time i is expressed as ω′ᵢ, if negotiation continues at time t, the total history information D from time 0 to time t is expressed as Expression (1).

$$\begin{matrix}[ Expression 1 ] & \\ = ( {ω}_{0} , {ω}_{0}^{′} , … , {ω}_{t} , {ω}_{t}^{′} ) & ( 1 )\end{matrix}$$

In order to facilitate use of the history information as input to the own action model, the history information generation unit 191 may perform one-hot encoding of the proposal for each item of the proposal. The item represents the type of proposal content. For example, in travel negotiations, the items may represent the destination and the travel cost.

For example, destinations in travel negotiations may be expressed using dummy variables such “100” for Montreal, “010” for Yokohama, and “001” for Macau. The travel costs may also be expressed using dummy variables such as “100” for 100 dollars, “010” for 500 dollars, and “001” for 1,000 dollars. In such a case, the history information generation unit 191 may express a proposal in the form of a vector of dummy variables for each item [001, 010], which represents Macau as the destination and $500 as the travel cost.

However, the conversion performed by the history information generation unit 191 is not limited to a specific one, and various conversions may be used to convert history information into data in a format that can be easily processed in the own action model. The data format in which the history information generation unit 191 converts history information is not limited to the form of a vector of dummy variables as described above, but may also be various data formats represented by vectors. For example, elements of a vector and input nodes of an own action model configured using a neural network may be in one-to-one correspondence.

The action determination unit 192 inputs history information into the own action model and calculates own action information.

The learning control unit 193 controls learning of the own action model based on the own utility value obtained from the data generation device 200. Specifically, the learning control unit 193 updates the parameter values of the own action model so that the evaluation indicated by the own utility value becomes as high as possible.

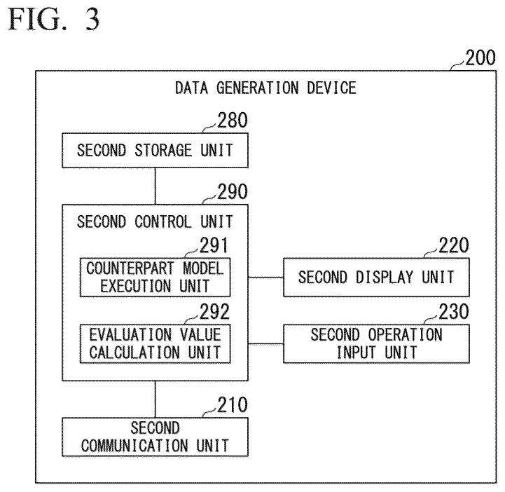

FIG. 3 is a diagram showing a configuration example of the data generation device 200. In the configuration shown in FIG. 3, the data generation device 200 includes a second communication unit 210, a second display unit 220, a second operation input unit 230, a second storage unit 280, and a second control unit 290. The second control unit 290 includes a counterpart model execution unit 291 and an evaluation value calculation unit 292.

The second communication unit 210 communicates with other devices. For example, the second communication unit 210 communicates with the learning device 100, receives own action information from the learning device 100, and transmits counterpart's action information and the own utility value for the counterpart's action information to the learning device 100.

The second display unit 220 includes a display screen such as a liquid crystal panel or an LED panel, and displays various types of images. For example, the second display unit 220 may display information indicating various settings related to the negotiation counterpart, such as the strategy setting for the negotiation counterpart.

Strategies here may be criteria, rules, or algorithms for determining actions or parts thereof, such as a method for determining a proposal based on a utility function, or a method for determining whether or not to accept the negotiation counterpart's proposal.

The second operation input unit 230 includes input devices such as a keyboard and a mouse, and accepts user operations. For example, the second operation input unit 230 may accept a user operation to perform settings related to the negotiation counterpart.

The second storage unit 280 stores various types of data. For example, the second storage unit 280 stores a counterpart utility function for calculating a counterpart's utility value. The counterpart's utility value is a value indicating the evaluation of an own action for the negotiation counterpart simulated by the data generation device 200.

Among the actions in negotiation, the one that requires evaluation based on a utility value is a proposal that continues to be negotiated. Therefore, when an action is the proposal, the utility function receives an input of the proposal and outputs a utility value. Upon receiving an input of a proposal, the counterpart utility function outputs a counterpart's utility value indicating the evaluation of the proposal for the negotiation counterpart.

Moreover, the second storage unit 280 stores an own utility function for calculating an own utility value. The own utility function receives an input of the proposal and outputs an own utility value.

Moreover, when the model that simulates the negotiation counterpart is implemented as software, the second storage unit 280 stores the software that represents the negotiation counterpart.

The second control unit 290 controls each unit of the data generation device 200 and executes various processes. Functions of the second control unit 290 are executed, for example, by a CPU included in the data generation device 200 reading out a program from the second storage unit 280 and executing the program.

The counterpart model execution unit 291 determines the counterpart's action, using a model that simulates the negotiation counterpart.

The evaluation value calculation unit 292 calculates an own utility value by inputting the counterpart's action information into the own utility function. As described above regarding the utility function, only when the counterpart's action is the proposal, the evaluation value calculation unit 292 may calculate an own utility value by inputting the proposal into the own utility function.

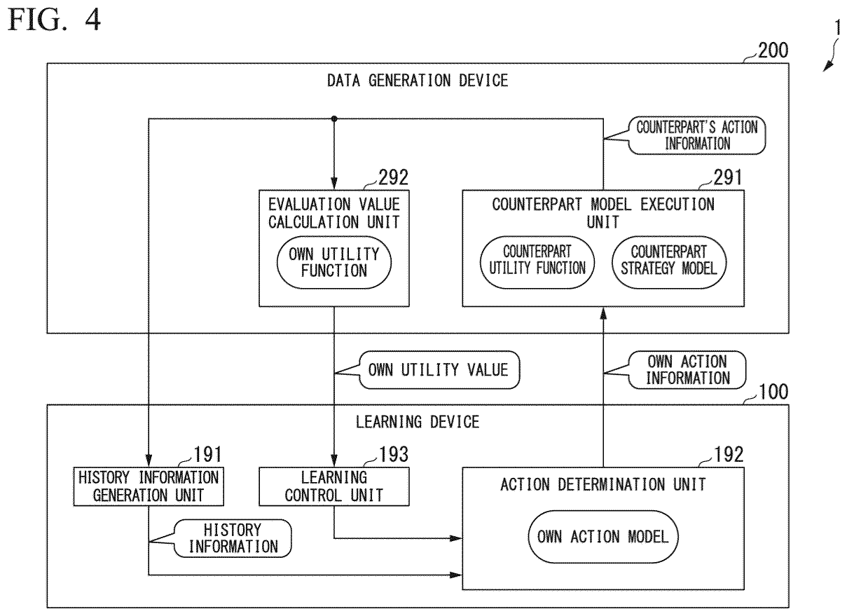

FIG. 4 is a diagram showing an example of data input/output in the learning system 1.

In the configuration shown in FIG. 4, the action determination unit 192 inputs history information input from the history information generation unit 191 into the own action model, and calculates own action information.

Upon receiving an input of the own action information from the action determination unit 192, the counterpart model execution unit 291 determines the action of the negotiation counterpart. Specifically, the counterpart model execution unit 291 inputs the own action information into the counterpart utility function, and calculates the utility value of the own action for the negotiation counterpart. As mentioned above, calculation of the utility value is necessary when an action is the proposal, and when an own action is the proposal, the counterpart model execution unit 291 inputs the proposal into the counterpart utility function to calculate the utility value. The counterpart model execution unit 291 determines a counterpart action using the calculated utility value and the counterpart strategy model, and outputs counterpart's action information.

On the other hand, the negotiation ends in both cases where the own action is acceptance or rejection. In such a case, the counterpart model execution unit 291 does not determine a new counterpart action.

The counterpart strategy model is a model that determines the negotiation counterpart's action upon receiving an input of own action information or negotiation history information. The counterpart utility function and the counterpart strategy model are not limited to specific ones.

For example, the counterpart strategy model may include: a predetermined equation for setting a threshold value for the utility value exemplified by Expression (6) or Expression (7) described later; a rule for determining whether or not to accept the own proposal based on a threshold value; and a rule for selecting one of proposal options based on a threshold value, when making a proposal. Then, the counterpart model execution unit 291 may set a threshold value based on the predetermined equation, and determine to accept the own proposal if the counterpart's utility value for the own proposal is equal to or greater than the threshold value. Furthermore, if the counterpart's utility value for the own proposal is less than the threshold value, the counterpart model execution unit 291 may select from proposal options a proposal that makes the counterpart's utility value equal to or greater than the threshold value, and may make the counterpart's proposal as the counterpart's action.

However, the counterpart strategy model is not limited to this example, and may be configured using a neural network as in the case of the own action model, for example.

It is also possible to prepare a plurality of counterpart strategy models and counterpart utility functions, and switch the counterpart strategy models and counterpart utility functions to train the own action model for various strategies and utilities (values). This is expected to enable the user to beneficially negotiate with the negotiation counterpart, using various strategies and utilities during operation.

The evaluation value calculation unit 292 inputs the counterpart's action information calculated by the counterpart model execution unit 291, into the own utility function to calculate the own utility value. As mentioned above, calculation of the utility value is necessary only when an action is the proposal. Therefore, the evaluation value calculation unit 292 may calculate the own utility value only when the counterpart's action is the proposal. The own utility value calculated by the evaluation value calculation unit 292 is input to the learning control unit 193 of the learning device 100.

The learning control unit 193 controls the learning of the own action model so that the evaluation indicated by the own utility value becomes as high as possible. As a learning method used by the learning control unit 193, a commonly known method such as error backpropagation can be used.

Also, the counterpart's action information is input to the history information generation unit 191, and the history information generation unit 191 generates negotiation history information. The history information is used as an input to the own action model. The history information generation unit 191 may perform one-hot encoding on the history information as described above.

With the configuration shown in FIG. 4, the learning system 1 performs the learning of the own action model through reinforcement learning. The reinforcement learning here refers to machine learning for learning policies, which are action rules for an agent in a certain environment, based on the action the agent takes, the observed state of the environment or the agent, and the reward that represents the evaluation of the state or agent's action.

In the learning of the own action model, the action determination unit 192 that determines the own action using the own action model is treated as an agent, and the own action is treated as an action in reinforcement learning. Also, the own action model is treated as a policy. Furthermore, the history information output by the history information generation unit 191 to the action determination unit 192 is treated as information representing the state, and the own utility value calculated by the evaluation value calculation unit 292 or the value based on the own utility value is treated as a reward value.

The learning control unit 193 updates the parameter values of the own action model so that the evaluation indicated by the own utility value becomes as high as possible. Here, the own action model corresponds to a model in machine learning, and updating the parameter values of the own action model corresponds to model learning.

Here, the action determination unit 192 or the own action model is described as performing the learning of the own action model, and the learning control unit 193 is described as controlling the learning of the own action model performed by the action determination unit 192. Alternatively, the learning control unit 193 may be described as performing the learning of the own action model.

The reinforcement learning used for the learning of the own action model is not limited to a specific type, and various types of reinforcement learning may be used. Furthermore, the configuration of the learning system 1 may be modified according to the type of reinforcement learning applied to the learning of the own action model. For example, when performing reinforcement learning explicitly dealing with a reward function, the evaluation value calculation unit 292 and the learning control unit 193 may be integrally configured and provided in the learning device 100 to allow the learning control unit 193 to become aware of the own utility function corresponding to the example of the reward function.

As the history information that the history information generation unit 191 outputs to the action determination unit 192, a part of the total history information D from time 0 shown in Expression (1) may be used. For example, the history information generation unit 191 may generate and output history information from L steps before in the time steps as the history information at time t, as shown in Expression (2).

$$\begin{matrix}[ Expression 2 ] & \\ {s}_{t} = \{ {ω}_{t - L} , {ω}_{t - L}^{′} , … , {ω}_{t} , {ω}_{t}^{′} , t / T \} & ( 2 )\end{matrix}$$

L is a positive integer constant.

sₜ represents the history information at time t. This history information is also referred to as state information (in reinforcement learning).

T represents a predetermined negotiation end time. If negotiations do not reach an agreement by the negotiation end time T, the negotiation will be concluded, and it will be considered unsuccessful.

Thus, the history information generation unit 191 includes not only the most recent counterpart's proposal ω′ₜ but also past counterpart's proposals and the most recent and past own proposals in the history information sₜ. Thereby, the learning control unit 193 can control the learning of the own action model so that the action determination unit 192 determines the own action based on the negotiation process.

As a reward function in the reinforcement learning, a reward function that outputs a reward at the end of negotiation may be used.

For example, if the proposal is accepted by itself, the own utility value U(ω′ₜ) for the employed proposal, which is the final counterpart's proposal ω′ₜ, may be used as a reward. The reward in this case is represented as in Expression (3).

$$\begin{matrix}[ Expression 3 ] & \\ r ( \{ … , {ω}_{t}^{′} \} , {η}_{t + 1} ) = U ( {ω}_{t}^{′} ) & ( 3 )\end{matrix}$$

The function r represents a reward function. “{ . . . ,ω′1}” represents one episode in reinforcement learning. “η^{t+1}” represents the acceptance as final own action.

If the proposal is accepted by the counterpart, the own utility value U(ω′ₜ) for the employed proposal, which is the final own proposal ω′ₜ, may be used as a reward. The reward in this case is represented as in Expression (4).

$$\begin{matrix}[ Expression 4 ] & \\ r ( \{ … , {ω}_{t}^{′} , {η}_{t + 1}^{′} \} {ω}_{t} ) = U ( {ω}_{t}^{′} ) & ( 4 )\end{matrix}$$

As in Expression (3), the function r represents a reward function. “η′ₜ₊₁” represents acceptance of the counterpart. “{ . . . ,ω′ₜ,η′ₜ₊₁}” represents one episode in the reinforcement learning. “ωₜ” represents the proposal as final own action.

If the negotiations end without reaching an agreement, a penalty K may be given as a reward. K may be a predetermined constant.

However, the reward function used for learning the own action model is not limited to a specific one, and various reward functions may be used according to the reinforcement learning employed. Depending on the type of reinforcement learning, the reward function may be unknown.

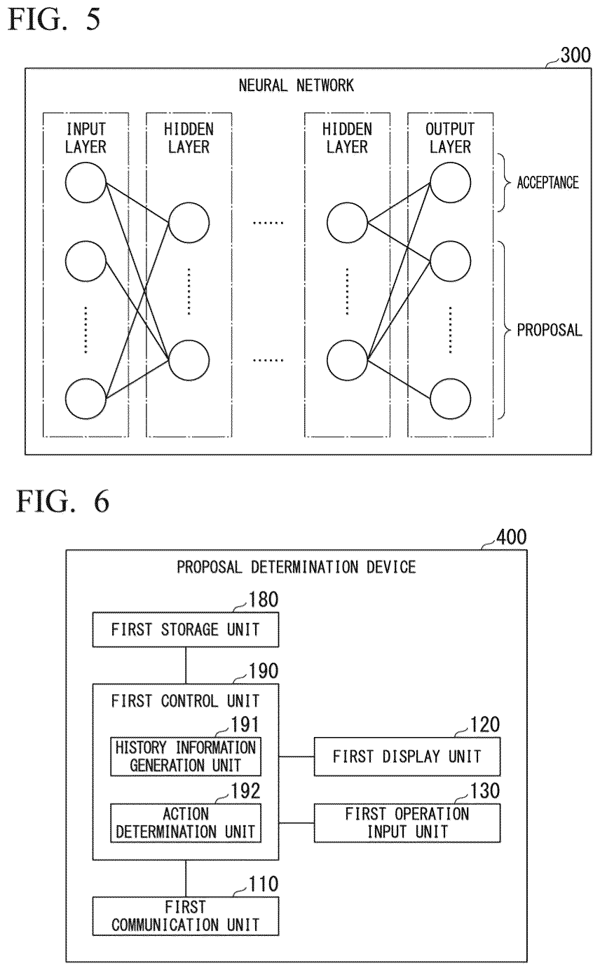

FIG. 5 is a diagram showing an example of the own action model in the case of using a neural network.

A neural network 300 shown in FIG. 5 includes an input layer, a plurality of hidden layers, and an output layer. The history information output by the history information generation unit 191 is input to the input layer nodes. As described above, one-hot encoded history information may be input to the nodes of the input layer.

The output layer is provided with one node that indicates whether or not a proposal has been accepted, and a plurality of nodes that indicate the content of the proposal when making a proposal. If rejection can be selected as an action in negotiation, a node indicating whether or not the proposal has been rejected may be further provided. Alternatively, if the own side is not to accept a proposal, the node to indicate whether or not the proposal has been accepted need not be provided.

The method of expressing the content of a proposal is not limited to a specific method. For example, the neural network 300 may output data in a one-hot encoding format similar to the history information that is input data.

However, the configuration of the own action model is not limited to a specific one. The own action model may be configured using a machine learning model other than a neural network. For example, the own action model may be configured as a policy-function-based model. Then, the action determination unit 192 may calculate the own action information by inputting the history information into the policy function. Alternatively, the own action model may include both a value function such as Actor-Critic and a policy function. Then, the action determination unit 192 may update the policy function based on the evaluation of the policy function by the evaluation function.

Furthermore, if the own action model is configured using a neural network, the configuration of the neural network is not limited to a specific one. For example, the own action model may be configured using a convolutional neural network (CNN) or a recurrent neural network (RNN), but is not limited thereto.

FIG. 6 is a diagram showing a configuration example of a proposal determination device according to the example embodiment. In the configuration shown in FIG. 6, a proposal determination device 400 includes a first communication unit 110, a first display unit 120, a first operation input unit 130, a first storage unit 180, and a first control unit 190. The first control unit 190 includes a history information generation unit 191 and an action determination unit 192.

Of the units shown in FIG. 6, ones corresponding to those in FIG. 2 and having the same functions are given the same reference symbols (110, 120, 130, 180, 190, 191, and 192), and descriptions thereof are omitted.

The proposal determination device 400 is a device that performs automated negotiation using the own action model trained by the learning system 1. The proposal determination device 400 in FIG. 6 has the same configuration as the learning device 100 in FIG. 2 except that the learning control unit 193 is removed. In other respects, the proposal determination device 400 is the same as the learning device 100.

The data format of input/output data of the own action model in the proposal determination device 400 can be the same as that of the own action model in the learning control unit 193. Moreover, since the own action model has already been trained in the proposal determination device 400, the learning control unit 193 is not necessary.

The learning device 100 may be used directly as the proposal determination device 400, and the learning control unit 193 may simply not be used. Alternatively, when the learning device 100 is directly used as the proposal determination device 400, the own action model may be periodically trained to update the own action model.

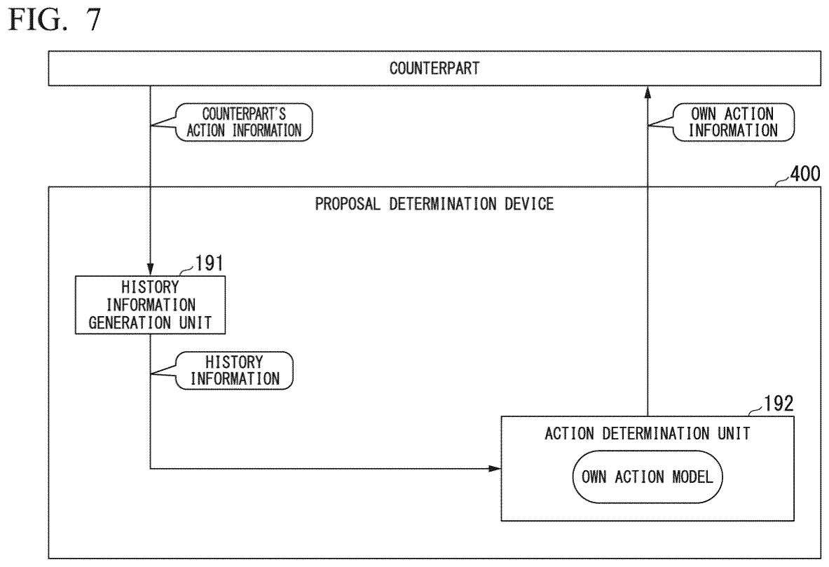

FIG. 7 is a diagram showing an example of data input/output in the proposal determination device 400.

Comparing the proposal determination device 400 shown in FIG. 7 with the learning device 100 shown in FIG. 4, the proposal determination device 400 does not include the learning control unit 193 and does not need to acquire own utility values. In other respects, the proposal determination device 400 shown in FIG. 7 is the same as the learning device 100 shown in FIG. 4.

When performing learning of the own action model by the learning device 100, the learning control unit 193 controls the learning based on the own utility value so that the own action model outputs own action information that increases the evaluation indicated by the own utility value. Thereby, the learning is performed such that the own action model outputs own action information that takes into account the evaluation based on the own utility value.

The proposal determination device 400 that uses a trained own action model can calculate and output own action information that reflects the evaluation indicated by the own utility value, without the need to specify the own utility function or own utility value.

As one way for a negotiation device (proposal determination device) that performs automated negotiation to determine actions in negotiations, a method may be considered such that the negotiation device determines its own actions by pre-reading the negotiation counterpart's evaluation or action for the own action, and taking into account the negotiation counterpart's evaluation or action. In comparison with the negotiation device in such a case, the proposal determination device 400 will be further explained.

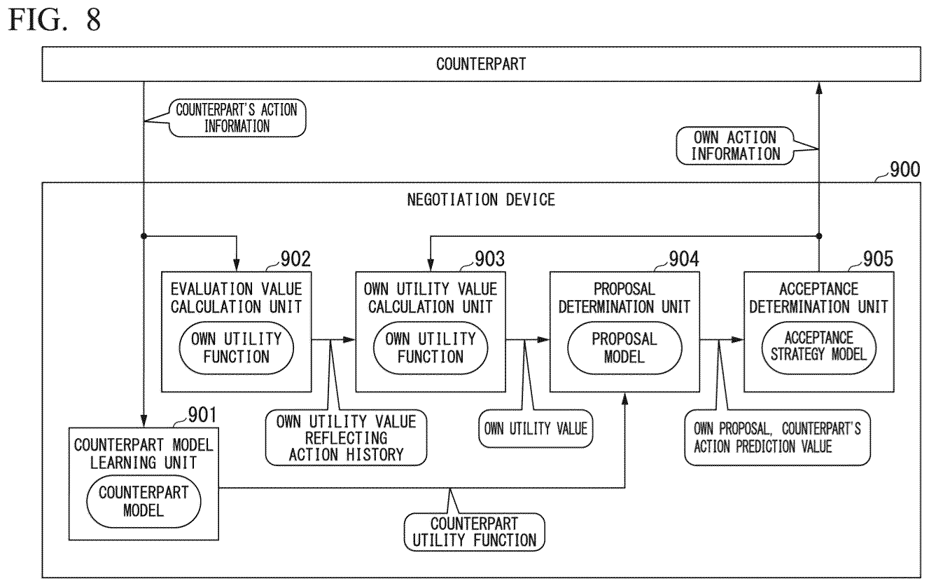

FIG. 8 is a diagram showing a configuration example of a negotiation device that pre-reads the action of the negotiation counterpart.

A negotiation device 900 shown in FIG. 8 includes a counterpart model learning unit 901, an evaluation value calculation unit 902, an own utility value calculation unit 903, a proposal determination unit 904, and an acceptance determination unit 905.

The counterpart model learning unit 901 uses counterpart's action information or negotiation history information to perform learning of a counterpart model that indicates the counterpart utility function. The counterpart model learning unit 901 outputs a utility function obtained through learning or a utility value calculated using the utility function.

The evaluation value calculation unit 902 outputs an own utility value reflecting action history. More specifically, the evaluation value calculation unit 902 inputs the counterpart's action information into the own utility function and calculates the own utility value for the counterpart action. As mentioned above, calculation of the utility value is necessary only when an action is the proposal. Therefore, the evaluation value calculation unit 902 may calculate the own utility value only when the counterpart's action is the proposal.

The own utility value calculation unit 903 calculates the own utility value by inputting into the own utility function, the own action information scheduled to be proposed by the negotiation device 900 to the negotiation counterpart.

Based on the own utility value from the own utility value calculation unit 903 and the counterpart utility function or the counterpart's utility value from the counterpart model learning unit 901, the proposal determination unit 904 plans the own proposal such that the counterpart's utility value and the own utility value both satisfy predetermined conditions. For example, the proposal determination unit 904 solves an optimization problem that maximizes the own utility function using the counterpart utility function as one of the constraints, and calculates the own utility value such that the counterpart's utility value and the own utility value are both large.

The proposal determination unit 904 also performs learning of the strategy of the negotiation counterpart, and calculates a counterpart action predicted value indicating the predicted action of the counterpart.

The acceptance determination unit 905 inputs the own proposal determined by the own utility value calculation unit 903 and the negotiation counterpart's action predicted by the proposal determination unit 904 into an acceptance strategy model, and determines the own action. For example, the acceptance determination unit 905 determines the own action to either employ the own proposal determined by the own utility value calculation unit 903 or to accept the most recent counterpart's proposal.

The acceptance strategy model is a model for determining whether or not to accept the proposal of the counterpart. For example, similar to what has been described above regarding the counterpart strategy model, the acceptance strategy model may include: a predetermined equation for setting a threshold value for the utility value; a rule for determining whether or not to accept the counterpart's proposal based on a threshold value; and a rule for selecting one of proposal options based on a threshold value, when making a proposal. Then, the acceptance determination unit 905 may set a threshold value based on the predetermined equation, and determine to accept the counterpart's proposal if the own utility value for the counterpart's proposal is equal to or greater than the threshold value.

However, the acceptance strategy model is not limited to this example, and may be configured using a neural network as in the case of the own action model, for example.

During operation, the negotiation device 900 in FIG. 8 determines actions while evaluating the contents of negotiation using the own utility function and the counterpart utility function. However, utility cannot necessarily be obtained in the form of a function. In the negotiation device 900 of FIG. 8, if utility cannot be obtained in the form of a function, it is conceivable that actions cannot be evaluated. In this respect, if utility cannot be obtained in the form of a function, the negotiation device 900 cannot be applied.

Furthermore, since the counterpart utility function varies depending on the negotiation counterpart, the negotiation device 900 needs to learn the actual utility function of the negotiation counterpart during operation. The negotiation device 900 may not be able to select an appropriate action until learning of the counterpart utility function progresses.

In contrast to this, the proposal determination device 400 does not require either the own utility function nor the counterpart utility function during operation. Therefore, if utility cannot be obtained in the form of a function, the proposal determination device 400 can be applied.

Moreover, the proposal determination device 400 does not need to learn the negotiation counterpart utility function during operation. Hence, the proposal determination device 400 does not encounter problems of being unable to select appropriate actions until the learning of the counterpart utility function progresses.

As described above, the history information generation unit 191 stores history information about proposals which have been implemented in negotiations.

The history information generation unit 191 corresponds to an example of the history information acquisition means.

Alternatively, when performing the learning of the own action model through reinforcement learning, history information corresponds to information representing a state. Considering this, the data generation device 200 can be regarded as a device simulating the environment in the reinforcement learning, and the data generation device 200 may incorporate therein the history information generation unit 191 to generate history information. Then, the data generation device 200 may transmit the history information to the learning device 100. In such a case, the action determination unit 192 that acquires history information in the learning device 100 and inputs it into the own action model corresponds to an example of the history information acquisition means.

Furthermore, the evaluation value calculation unit 292 calculates the own utility value corresponding to the evaluation value for the proposal from the negotiation counterpart. The learning control unit 193 then acquires the own utility value from the evaluation value calculation unit 292 and controls the learning of the own action model.

The learning control unit 193 corresponds to an example of the evaluation value acquisition means.

Moreover, the action determination unit 192 performs the learning of the own action model under control of the learning control unit 193 based on the history information and the own utility value. The action determination unit 192 outputs own action information indicating the own proposal to the negotiation counterpart, based on the proposal determination method using the own action model.

The action determination unit 192 corresponds to an example of the learning means. The learning of the own action model performed by the action determination unit 192 corresponds to an example of learning the method for determining the own proposal to the negotiation counterpart.

Moreover, upon receiving an input of the own proposal to the negotiation counterpart, the counterpart model execution unit 291 outputs counterpart's action information indicating the proposal from the negotiation counterpart. The counterpart model execution unit 291 corresponds to an example of the counterpart model execution means.

Upon receiving an input of the counterpart's action information indicating the proposal from the negotiation counterpart, the evaluation value calculation unit 292 applies the counterpart's action information to the own utility function, and outputs the own utility value corresponding to the own evaluation value for the proposal from the negotiation counterpart. The evaluation value calculation unit 292 corresponds to an example of the evaluation means.

In the learning system 1, by performing learning using proposal history information, it is possible to perform learning such that the response of the counterpart to the own action is reflected in the proposal determination method. Since the counterpart's response to the own action is reflected in the proposal determination method, there is no need for the proposal determination device 400 during operation to set or learn the utility and strategy of the negotiation counterpart.

Thus, according to the learning system 1 during learning and the proposal determination device 400 during operation, there is no need to explicitly predict the action of the negotiation counterpart. Therefore, according to the learning system 1 during learning and the proposal determination device 400 during operation, automated negotiations can be performed even if the utility function or utility value, or strategy of the counterpart is unknown during operation.

Moreover, the history information generation unit 191 outputs the history information in vector format data. As an own action model, the action determination unit 192 includes a neural network that, upon receiving an input of history information in the vector format data, outputs its own proposal to the negotiation counterpart.

In the learning device 100, history information can be input to the neural network in the form of vector format data suitable for input to the neural network. According to the learning device 100, in this respect, it is expected that learning of the own action model configured using a neural network will be possible with high accuracy.

In the proposal determination device 400, the history information generation unit 191 acquires history information about proposals which have been implemented in negotiations. As described above, the history information generation unit 191 corresponds to an example of the history information acquisition means.

The action determination unit 192 inputs history information acquired by the history information generation unit 191 into the own action model that has been trained based on the history information of proposals made in negotiations and evaluation values of proposals from negotiation counterpart, and acquires and outputs an own proposal to the negotiation counterpart. The action determination unit 192 corresponds to an example of the proposal output means.

As described above, during learning, learning of the own action model can be performed using a combination of the counterpart utility function and the counterpart strategy model. Thereby, the action determination method according to the utility and strategy of the negotiation counterpart is reflected in the own action model, and there is no need in the proposal determination device 400 to set or learn the utility and strategy of the negotiation counterpart during operation.

Thus, according to the proposal determination device 400, automated negotiations can be performed even if the utility function or utility value, or strategy of the counterpart is unknown during operation.

The learning system 1 and the proposal determination device 400 can be applied to various types of negotiations. The learning system 1 and the proposal determination device 400 can be used for various types of negotiations including, but not limited to, price negotiations.

For example, the learning system 1 or the proposal determination device 400 may be used to adjust the equipment lending destination and lending period. Moreover, the learning system 1 or the proposal determination device 400 may perform procedures for lending the determined equipment.

Furthermore, the learning system 1 or the proposal determination device 400 may be used for various adjustments related to either time or place, or both, such as delivery date adjustment for manufactured parts, schedule adjustments for logistics, or route adjustments for logistics.

Also, the learning system 1 and the proposal determination device 400 can be applied not only to negotiations but also to various decision making based on a combination of multiple strategies.

For example, the learning system 1 or the proposal determination device 400 may formulate a plant operation plan based on a plurality of evaluation criteria. Furthermore, the learning system 1 or the proposal determination device 400 may control the plant based on the formulated operation plan.

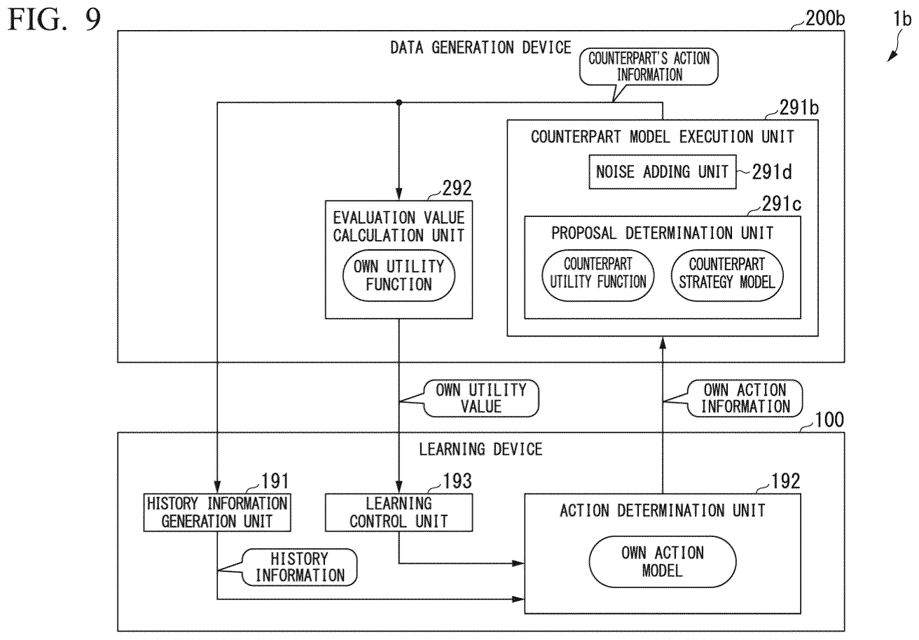

FIG. 9 is a diagram showing an example of a learning system 1b according to a modified example of the learning system 1. In the learning system 1b shown in FIG. 9, a counterpart model execution unit 291b of a data generation device 200b includes a proposal determination unit 291c and a noise adding unit 291d. In other respects, the learning system 1b is the same as the learning system 1. The learning system 1b corresponds to an example of the learning system 1. The data generation device 200b corresponds to an example of the data generation device 200.

The proposal determination unit 291c is the same as the counterpart model execution unit 291 of the learning system 1. Specifically, the proposal determination unit 291c inputs own action information obtained from the learning device 100 into the counterpart utility function, and calculates the utility value of the own action for the negotiation counterpart. As described above, calculation of the utility value is necessary only when an action is the proposal. Therefore, the proposal determination unit 291c may calculate the utility value only when the own action is the proposal. The proposal determination unit 291c determines a counterpart action using the calculated utility value and the counterpart strategy model, and outputs counterpart's action information.

The proposal determination unit 291c corresponds to an example of the proposal determination means.

The noise adding unit 291d adds noise to a proposal from the negotiation counterpart determined by the proposal determination unit 291c.

For example, the noise adding unit 291d may add noise to the counterpart's utility value, which is the utility value used by the proposal determination unit 291c to determine the counterpart action. In such a case, the counterpart's utility value after adding noise thereto is expressed as Expression (5), for example.

$$\begin{matrix}[ Expression 5 ] & \\ {U}_{opp} ( ω ) + ε , ε ∼ ( μ , {σ}^{2} ) & ( 5 )\end{matrix}$$

ω represents the own proposal obtained from the learning device 100. The function Uₒₚₚ represents the counterpart utility function, and Uₒₚₚ (ω) represents the counterpart's utility value before noise is added. ε represents Gaussian noise. N(μ,σ²) represents a Gaussian distribution, and ε˜N(μ,σ²) represents that & follows a Gaussian distribution with mean μ and variance σ².

The noise adding unit 291d adding noise to the counterpart's utility value causes the proposal determination unit 291c to calculate different counterpart's action information for the same own utility value w, and variation in the learning data of the own action model increases. In particular, even in the case where the counterpart strategy model is a deterministic model, by adding noise to the counterpart's utility value in the noise adding unit 291d, a learning dataset containing total history information D of various patterns (see Expression (1)) can be obtained.

However, the method by which the noise adding unit 291d adds noise to proposals is not limited to the method of adding noise to the counterpart's utility value. For example, in the case where the proposal determination unit 291c outputs counterpart's proposal as a proposal, indicating that quantitative information such as the number of items to be delivered can be edited, the noise adding unit 291d may add noise by rewriting this quantitative information.

Thus, the proposal determination unit 291c determines a proposal according to the own proposal to the negotiation counterpart. The noise adding unit 291d adds noise to the counterpart's proposal determined by the proposal determination unit 291c.

According to the learning system 1b, it is expected that the variation in the learning data of the own action model increases, the learning of the own action model progresses, and overlearning can be avoided in learning the own action model.

An experiment using the configuration of the learning system 1b will be described. In the following, the system will be referred to as learning system 1b both during learning and during testing (operating). In the description of the experiment results, the learning system 1b and the proposal determination device 400 will not be expressed in a differentiated manner.

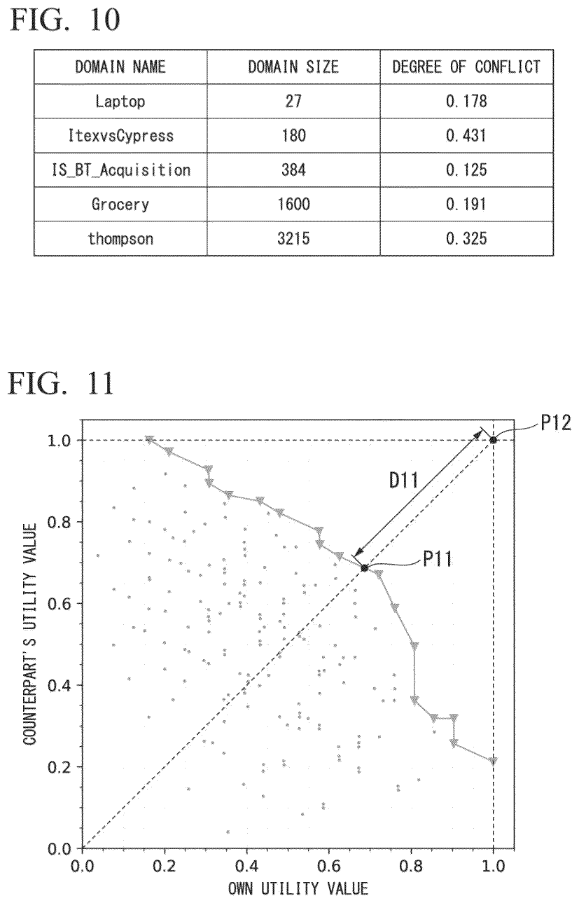

FIG. 10 is a diagram showing characteristics of domains used in the experiment. The domains here refer to negotiation settings. Specifically, the proposals that can be selected differ depending on the domain.

In the experiment, learning and testing were performed using five domains whose domain names are shown in FIG. 10. In FIG. 10, the domain size and degree of conflict are shown for each domain.

Domain size represents the type of selectable proposal.

The degree of conflict is the Euclidean distance between the point (1, 1) where both the own utility value and the counterpart's utility value are maximum, and the KS solution (Kalai-Smorodinsky Solution).

FIG. 11 is a diagram showing an example of the degree of conflict. The horizontal axis of the graph in FIG. 11 represents own utility value and the vertical axis represents counterpart's utility value. Both own utility value and counterpart's utility value take real values in the range [0, 1]. In the graph of FIG. 11, selectable proposals are plotted at the coordinates of the own utility values and counterpart's utility values for the proposals.

Point P11 denotes the KS solution. The KS solution represents the intersection of the diagonal line connecting points (0, 0) and (1, 1) and the Pareto Frontier. In the example of FIG. 11, the proposal with the maximum own utility value among the proposals for each counterpart's utility value corresponds to the Pareto solution (Pareto Optimum Solution), and the boundary line obtained by connecting the Pareto solutions corresponds to the Pareto frontier. Also, the point (1, 1) is denoted as point P12.

The Euclidean distance D11 between the point P11 and the point P12 corresponds to the degree of conflict. The degree of conflict can be used as an index value indicating the difficulty of negotiation. The greater the degree of conflict, the more difficult it is to negotiate.

In the experiment, three types of time-dependent agents and two types of action-dependent agents were set as negotiation counterparts. The agents in the description of the experiment results are entities in automated negotiations.

A time-dependent agent changes the utility value setting according to the elapse of negotiation time. In the experiment, the utility values set by the time-dependent agents were defined as shown in Expression (6).

$$\begin{matrix}[ Expression 6 ] & \\ U ( {ω}_{t + 1} ) = {U}_{max} - ( {U}_{max} - {U}_{min} ) {( \frac{t}{T} )}^{- e} & ( 6 )\end{matrix}$$

t represents time in time steps. Time T is the negotiation end time, and t takes an integer value where “0≤t≤T”.

U(ωₜ₊₁) represents the utility value set at time t+1. An agent serving as a negotiation counterpart accepts a proposal in which the counterpart's utility value is greater than or equal to the set utility value. Furthermore, when making a proposal, an agent makes a proposal such that the counterpart's utility value is greater than or equal to the set utility value.

Uₘₐₓ is a constant defined as the maximum value of the utility value. Uₘᵢₙ is a constant defined as the minimum value of the utility value.

e is a hyper parameter, and the larger the value of e, the smaller the utility value set at an earlier time. In the experiment, three agents with e values of “0.1”, “1.0”, and “5.0” were set.

According to Expression (6), at time 0, the utility value is the maximum value Uₘₐₓ, and as time passes, the utility value setting becomes lower, and at time T, the utility value is the minimum value Uₘᵢₙ.

An action-dependent agent changes the utility value setting according to the action of the counterpart's action. In the experiment, the utility values set by the action-dependent agents were defined as shown in Expression (7).

$$\begin{matrix}[ Expression 7 ] & \\ U ( {ω}_{t + 1} ) = min ( max ( \frac{U ( {ω}_{t - δ}^{′} )}{U ( {ω}_{t}^{′} )} U ( {ω}_{t} ) , {U}_{min} ) , {U}_{max} ) & ( 7 )\end{matrix}$$

δ is a hyper parameter, and the agent compares the utility value U(ω′ₜ) at time t with the utility value U(ω′ₜ₋δ) at time t−δ. In the experiment, two agents with e values of “1” and “2” were set.

The utility values U(ω′ₜ) and U(ω′_{t-δ}) here are the agent's own utility values for the negotiation counterpart's proposal from the agent's perspective.

In the case of an agent as a negotiation counterpart, the setting of the utility value is changed within the range of Uₘᵢₙ or more and Uₘₐₓ or less, depending on the ratio of the counterpart's utility value to the own proposal between time t−δ and time t. For an agent as a negotiation counterpart, the larger the counterpart's utility value U(ω′ₜ) at time t is relative to the counterpart's utility value U(ω′_{t-δ}) at time t−δ, the more significantly the set value of the utility value U(ωₜ₊₁) at time t+1 is lowered from the set value of the utility value U(ωₜ) at time t.

If the counterpart's utility value U(ω′ₜ) at time t is smaller than the counterpart's utility value U(ω′_{t-δ}) at time t−δ, the agent as the negotiation counterpart makes the set value of the utility value U(ωₜ₊₁) at time t+1 larger than the set value of the utility value U(ωₜ) at time t.

In the experiment, the negotiation time limit was set to 40 rounds (40 time steps). In terms of learning, the learning was performed, using training data for 2,000 episodes. The ε-greedy method was used as a policy where “ε=0.01”. The penalty in the case of unsuccessful negotiations is set to “K=−1”. In addition, the Gaussian noise used during learning was noise that followed a Gaussian distribution of “(μ, σ)=(0, 5×10⁻³)”.

We used DDQN (Double Deep Q Network) as a deep reinforcement learning method.

As an evaluation index, the acquired utility when acting with a greedy policy after learning was used. The acquired utility here is the own utility value when the negotiation is concluded successfully. The greedy policy here corresponds to the case where &=0 in the s-greedy method.

Since initial values have a significant influence on performance, learning was performed with 100 different initial values, and the one with the best performance after learning was selected as the evaluation target.

Regarding the evaluation index values, the values were compared between the Random Agent and RLBOA-agent negotiation methods.

The Random Agent randomly selects a proposal from all available proposals. This proposal selection method corresponds to the proposal selection method by the learning device 100 before performing learning. Since learning is not performed for the Random Agent method, the average evaluation index value obtained from 100 negotiations was used.

The RLBOA-agent uses states and actions based on utility values proposed in previous research. The learning method used was DDQN. As with the evaluation method in the case of the learning system 1b, learning was performed using 100 types of initial values, and the one with the best performance after learning was selected as the evaluation target.

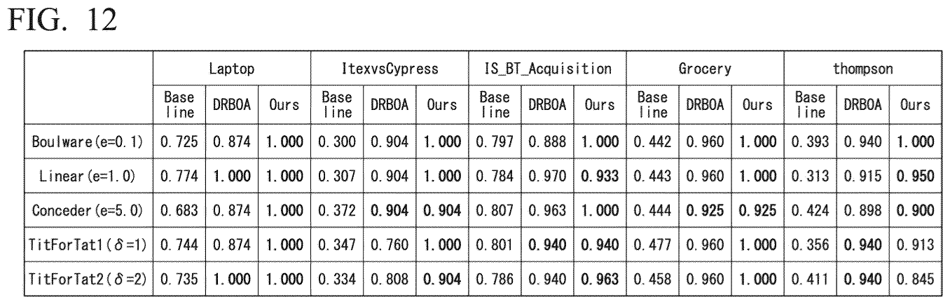

FIG. 12 is a diagram showing evaluation index values of the experiment results. FIG. 12 shows the evaluation index values for each of the five types of domains and five types of negotiation counterparts in comparison with the Random Agent and the RLBOA-agent.

The negotiation counterpart, Boulware, is a time-dependent agent set to “e=0.1”. Linear is a time-dependent agent set to “e=1.0”. Conceder is a time-dependent agent set to “e=5.0”. TitForTat1 is an action-dependent agent set to “δ=1”. TitForTat1 is an action-dependent agent set to “δ=2”.

Regarding the negotiation method, “Baseline” indicates a method using Random Agent. “DRBOA” indicates the case where RLBOA-agent and DDQN are used. “Ours” indicates the method by the learning system 1b.

The experiment results shown in FIG. 12 show that the evaluation index value of the learning system 1b is larger than that of Random Agent in all 25 settings based on the combination of domain and negotiation counterpart. In 23 of the 25 settings, the evaluation index value of the learning system 1b is larger than the evaluation index value of RLBOA-agent.

Also, in 15 of the 25 settings, the evaluation index value of the learning system 1b is “1”, which is the maximum value.

As it becomes evident, excellent experimental results were achieved.

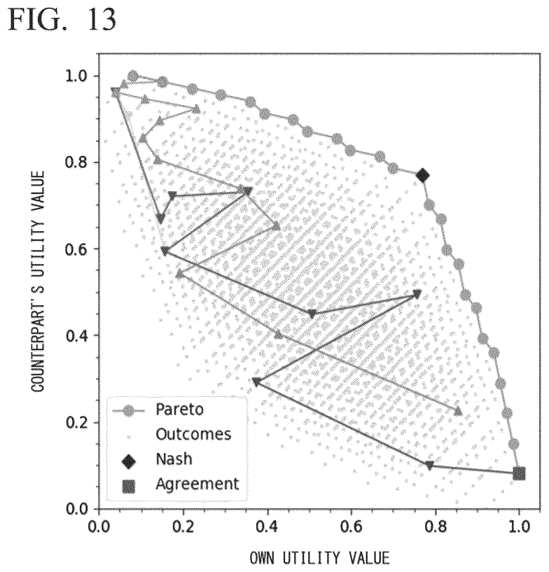

FIG. 13 is a diagram showing an example of a negotiation process within the learning system 1b when the negotiation counterpart is a time-dependent agent. FIG. 13 shows the negotiation process where the negotiation counterpart is a time-dependent agent with e=1.0 and the domain is “thompson”.

The horizontal axis of the graph in FIG. 13 represents time. The vertical axis shows the counterpart's utility value. The triangle (“▴” or “▾”) indicates a point where the utility value for the proposal is plotted. The square (“▪”) indicates a proposal that has been employed as an evaluation target and has obtained acquired utility. The circle (“•”) indicate a Pareto solution. The diamond (“♦”) indicate a KS solution.

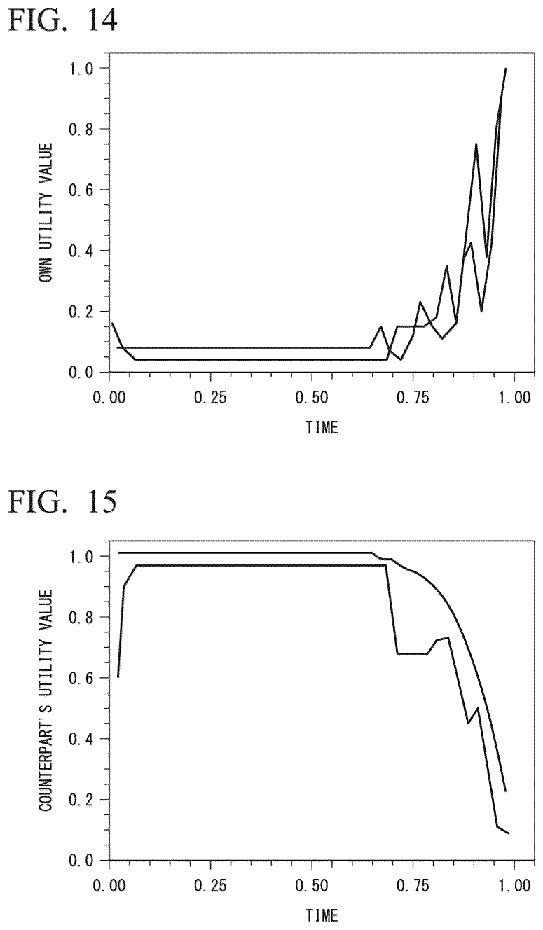

FIG. 14 is a diagram showing an example of variation in the own utility values when the negotiation counterpart is a time-dependent agent. The horizontal axis of the graph in FIG. 14 shows the elapsed time of negotiation as a value normalized with the negotiation end time set to 1. The vertical axis shows the counterpart's utility value. FIG. 14 shows changes in the own utility value during the negotiation process shown in FIG. 13.

FIG. 15 is a diagram showing an example of variation in the counterpart's utility values when the negotiation counterpart is a time-dependent agent. The horizontal axis of the graph in FIG. 15 shows the elapsed time of negotiation as a value normalized with the negotiation end time set to 1. The vertical axis shows the counterpart's utility value. FIG. 15 shows changes in the counterpart's utility value during the negotiation process shown in FIG. 13.

When the negotiation counterpart was a time-dependent agent, the learning system 1b appeared to have explored the negotiation counterpart's utility at the beginning of the negotiation, and took actions to obtain high utility at the end of the negotiation.

In the examples shown in FIG. 13 to FIG. 15, in the beginning of the negotiation, the counterpart's utility value shown in FIG. 15 is a large value, and the own utility value shown in FIG. 14 is a small value. This can be interpreted as the learning system 1b giving priority to investigating the negotiation counterpart's utility rather than increasing its own utility value in the early stages of the negotiation.

In the end of the negotiation, the own utility value shown in FIG. 14 is a large value, and the counterpart's utility value shown in FIG. 15 is a small value. This can be interpreted as the learning system 1b determining actions in the final stage of the negotiation, giving priority to increasing its own utility value.

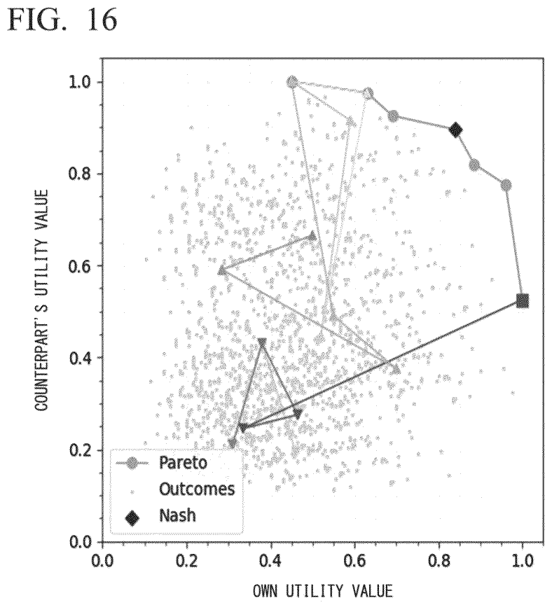

FIG. 16 is a diagram showing an example of a negotiation process within the learning system 1b when the negotiation counterpart is an action-dependent agent. FIG. 16 shows the negotiation process where the negotiation counterpart is an action-dependent agent with “8=2” and the domain is “Grocery”.

The horizontal axis of the graph in FIG. 16 represents time. The vertical axis shows the counterpart's utility value. The triangle (“▴” or “▾”) indicates a point where the utility value for the proposal is plotted. The square (“▪”) indicates a proposal that has been employed as an evaluation target and has obtained acquired utility. The circle (“•”) indicate a Pareto solution. The diamond (“♦”) indicate a KS solution.

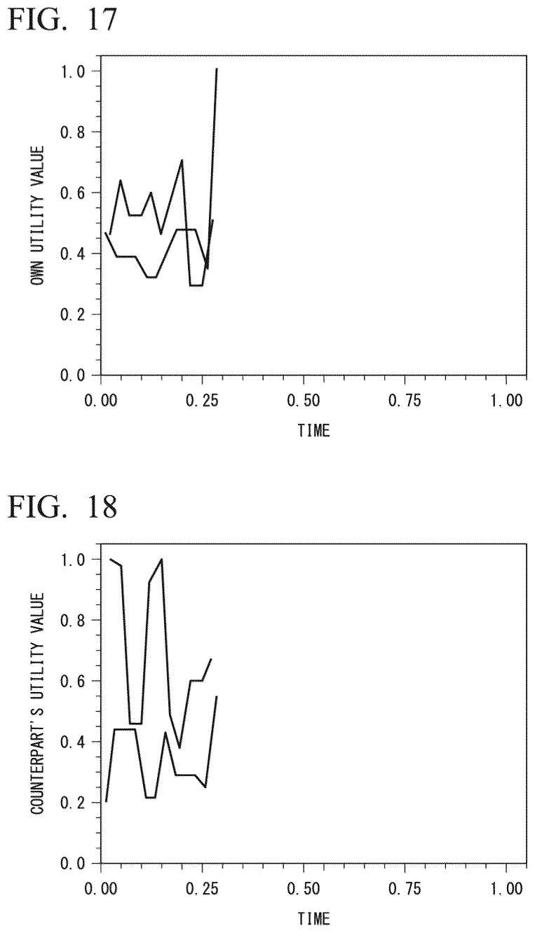

FIG. 17 is a diagram showing an example of variation in the own utility values when the negotiation counterpart is a time-dependent agent. The horizontal axis of the graph in FIG. 17 shows the elapsed time of negotiation as a value normalized with the negotiation end time set to 1. The vertical axis shows the counterpart's utility value. FIG. 17 shows changes in the own utility value during the negotiation process shown in FIG. 16.

FIG. 18 is a diagram showing an example of variation in the counterpart's utility values when the negotiation counterpart is a time-dependent agent. The horizontal axis of the graph in FIG. 18 shows the elapsed time of negotiation as a value normalized with the negotiation end time set to 1. The vertical axis shows the counterpart's utility value. FIG. 18 shows changes in the counterpart's utility value during the negotiation process shown in FIG. 16.

When the negotiation counterpart was an action-dependent agent, the learning system 1b appeared to have explored the negotiation counterpart's utility at the beginning of the negotiation, and took actions to obtain high utility at the end of the negotiation.

In the examples shown in FIG. 16 to FIG. 18, the learning system 1b often makes proposals that lower the counterpart's utility value. The counterpart's utility value shown in FIG. 18 repeatedly increases and decreases. When the counterpart's utility value changes from a small value to a large value, the set value of the counterpart's utility value is set to a relatively small value, facilitating to conclude the negotiation from the perspective of the learning system 1b. The negotiation is concluded successfully when the counterpart's utility value is greater than the value at the previous time step.

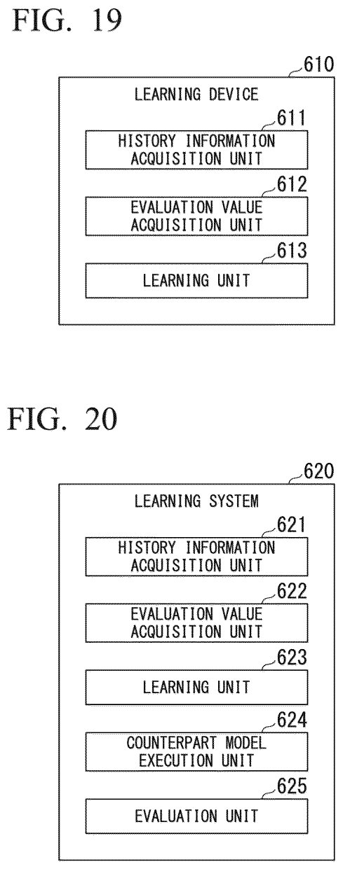

FIG. 19 is a diagram showing a configuration example of a learning device according to the example embodiment. In the configuration shown in FIG. 19, a learning device 610 includes a history information acquisition unit 611, an evaluation value acquisition unit 612, and a learning unit 613.

With such a configuration, the history information acquisition unit 611 acquires history information about proposals which have been implemented in negotiations. The evaluation value acquisition unit 612 acquires an evaluation value for the proposal from the negotiation counterpart. The learning unit 613 learns a determination method for an own proposal to the negotiation counterpart on the basis of the history information and the evaluation value.

The history information acquisition unit 611 corresponds to an example of the history information acquisition means. The evaluation value acquisition unit 612 corresponds to an example of the evaluation value acquisition means. The learning unit 613 corresponds to an example of the learning means.

In the learning device 610, by performing learning using proposal history information, it is possible to perform learning such that the response of the counterpart to the own action is reflected in the proposal determination method. Since the counterpart's response to the own action is reflected in the proposal determination method, there is no need during operation to set or learn the utility and strategy of the negotiation counterpart.

Thus, according to the learning device 610, automated negotiations can be performed even if the utility function or utility value, or strategy of the counterpart is unknown during operation.

The history information acquisition unit 611 can be implemented using the functions of the history information generation unit 191 and so forth shown in FIG. 2, for example. The evaluation value acquisition unit 612 and the learning unit 613 can be implemented using the functions of the action determination unit 192 and so forth shown in FIG. 2, for example.

FIG. 20 is a diagram showing a configuration example of a learning system according to the example embodiment. In the configuration shown in FIG. 20, the learning system includes a history information acquisition unit 621, an evaluation value acquisition unit 622, a learning unit 623, a counterpart model execution unit 624, and an evaluation unit 625.

With such a configuration, the history information acquisition unit 621 acquires history information about proposals which have been implemented in negotiations. The evaluation value acquisition unit 622 acquires an evaluation value for the proposal from the negotiation counterpart. The learning unit 623 learns a determination method for an own proposal to the negotiation counterpart on the basis of history information and evaluation values, and outputs its own proposal to the negotiation counterpart on the basis of the learned determination method. Upon receiving an input of the own proposal to the negotiation counterpart, the counterpart model execution unit 624 outputs the proposal from the negotiation counterpart. The evaluation unit 625, upon receiving an input of a proposal from the negotiation counterpart, outputs an evaluation value.

The history information acquisition unit 621 corresponds to an example of the history information acquisition means. The evaluation value acquisition unit 622 corresponds to an example of the evaluation value acquisition means. The learning unit 623 corresponds to an example of the learning means. The counterpart model execution unit 624 corresponds to an example of the counterpart model execution means. The evaluation unit 625 corresponds to an example of the evaluation means.

In the learning system 620, by performing learning using proposal history information, it is possible to perform learning such that the response of the counterpart to the own action is reflected in the proposal determination method. Since the counterpart's response to the own action is reflected in the proposal determination method, there is no need during operation to set or learn the utility and strategy of the negotiation counterpart.

Thus, according to the learning system 620, automated negotiations can be performed even if the utility function or utility value, or strategy of the counterpart is unknown during operation.

The history information acquisition unit 621 can be implemented using the functions of the history information generation unit 191 and so forth shown in FIG. 2, for example. The evaluation value acquisition unit 622 and the learning unit 623 can be implemented using the functions of the action determination unit 192 and so forth shown in FIG. 2, for example. The counterpart model execution unit 624 can be implemented using the functions of the counterpart model execution unit 291 and so forth shown in FIG. 3, for example. The evaluation unit 625 can be implemented using the functions of the evaluation value calculation unit 292 and so forth shown in FIG. 3, for example.

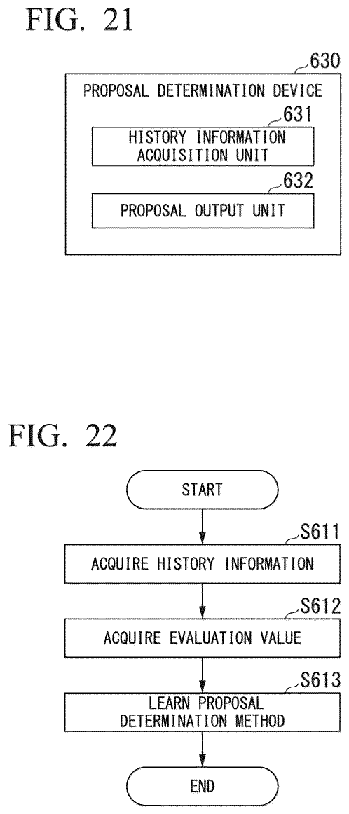

FIG. 21 is a diagram showing a configuration example of the proposal determination device according to the example embodiment. In the configuration shown in FIG. 21, a proposal determination device 630 includes a history information acquisition unit 631 and a proposal output unit 632.

With such a configuration, the history information acquisition unit 631 acquires history information about proposals which have been implemented in negotiations. The proposal output unit 632 inputs history information acquired by the history information acquisition unit 631 into the own action model that has been trained based on the history information of proposals made in negotiations and evaluation values of proposals from negotiation counterpart, and acquires and outputs an own proposal to the negotiation counterpart.

The history information acquisition unit 631 corresponds to an example of the history information acquisition means. The proposal output unit 632 corresponds to an example of the proposal output means.

The proposal determination device 630 uses a learned own action model based on history information of proposals made in negotiations and evaluation values of proposals from the negotiation counterpart, whereby the negotiation counterpart's response to the own action is expected to be reflected in the proposal determination method. Since the counterpart's response to the own action is reflected in the proposal determination method, there is no need for the proposal determination device 630 to set or learn the utility and strategy of the negotiation counterpart.

Thus, according to the proposal determination device 630, automated negotiations can be performed even if the utility function or utility value, or strategy of the counterpart is unknown during operation.

The history information acquisition unit 631 can be implemented using the functions of the history information generation unit 191 and so forth shown in FIG. 6, for example. The proposal output unit 632 can be implemented using the functions of the action determination unit 192 and so forth shown in FIG. 6, for example.

FIG. 22 is a diagram showing an example of a processing procedure in a learning method according to the example embodiment. The learning method shown in FIG. 22 includes acquiring history information (Step S611), acquiring an evaluation value (Step S612), and learning a proposal determination method (Step S613).

In the step of acquiring history information (Step S611), a computer acquires history information about proposals which have been implemented in negotiations. In the step of acquiring the evaluation value (Step S612), the computer acquires an evaluation value for the proposal from the negotiation counterpart. In the step of learning the proposal determination method (Step S613), the computer learns a determination method for an own proposal to the negotiation counterpart on the basis of the history information and the evaluation value.

In the learning method shown in FIG. 22, by performing learning using proposal history information, it is possible to perform learning such that the response of the counterpart to the own action is reflected in the proposal determination method. Since the counterpart's response to the own action is reflected in the proposal determination method, there is no need during operation to set or learn the utility and strategy of the negotiation counterpart.

Thus, according to the learning method shown in FIG. 22, automated negotiations can be performed even if the utility function or utility value, or strategy of the counterpart is unknown during operation.

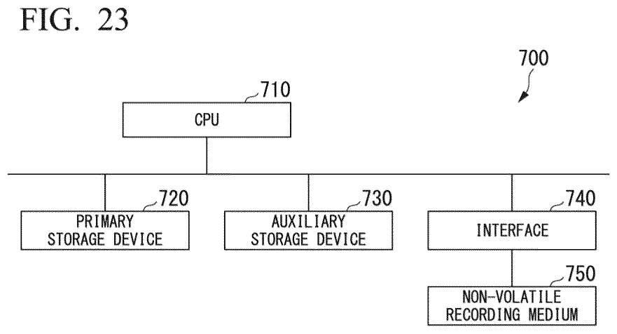

FIG. 23 is a schematic block diagram showing a configuration example of a computer according to at least one example embodiment.

In the configuration shown in FIG. 23, a computer 700 includes a CPU 710, a primary storage device 720, an auxiliary storage device 730, an interface 740, and a non-volatile recording medium 750.

One or more of the learning device 100, the data generation device 200, the proposal determination device 400, the data generation device 200b, the learning device 610, the learning system 620, and the proposal determination device 630, or part thereof may be implemented in the computer 700. In such a case, operations of the respective processing units described above are stored in the auxiliary storage device 730 in the form of a program. The CPU 710 reads out the program from the auxiliary storage device 730, loads it on the primary storage device 720, and executes the processing described above according to the program. Moreover, the CPU 710 reserves, according to the program, storage regions corresponding to the respective storage units mentioned above, in the primary storage device 720. Communication between each device and other devices is executed by the interface 740 having a communication function and communicating under the control of the CPU 710. The interface 740 also has a port for the non-volatile recording medium 750, and reads information from the non-volatile recording medium 750 and writes information to the non-volatile recording medium 750.

In the case where the learning device 100 is implemented in the computer 700, operations of the first control unit 190 and each component thereof are stored in the form of a program in the auxiliary storage device 730. The CPU 710 reads out the program from the auxiliary storage device 730, loads it on the primary storage device 720, and executes the processes described above, according to the program.

Moreover, the CPU 710 reserves, according to the program, a storage region corresponding to the first storage unit 180, in the main storage device 720.

Communication with another device performed by the first communication unit 110 is executed by the interface 740 having a communication function and operating under the control of the CPU 710. The displaying of images performed by the first display unit 120 is executed by the interface 740 including a display device and displaying images according to the control of the CPU 710. User operations are accepted through the first operation input unit 130 by the interface 740 having an input device and accepting user operations.

In the case where the data generation device 200 is implemented in the computer 700, operations of the second control unit 290 and each unit thereof are stored in the auxiliary storage device 730 in the form of program. The CPU 710 reads out the program from the auxiliary storage device 730, loads it on the primary storage device 720, and executes the processes described above, according to the program.

Moreover, the CPU 710 reserves, according to the program, a storage region corresponding to the second storage unit 280, in the main storage device 720.

Communication with another device performed by the second communication unit 210 is executed by the interface 740 having a communication function and operating under the control of the CPU 710. The displaying of images performed by the second display unit 220 is executed by the interface 740 including a display device and displaying images according to the control of the CPU 710. User operations are accepted through the second operation input unit 230 by the interface 740 having an input device and accepting user operations.

In the case where the proposal determination device 400 is implemented in the computer 700, operations of the first control unit 190 and each component thereof are stored in the form of a program in the auxiliary storage device 730. The CPU 710 reads out the program from the auxiliary storage device 730, loads it on the primary storage device 720, and executes the processes described above, according to the program.

Moreover, the CPU 710 reserves, according to the program, a storage region corresponding to the first storage unit 180, in the main storage device 720.

Communication with another device performed by the first communication unit 110 is executed by the interface 740 having a communication function and operating under the control of the CPU 710. The displaying of images performed by the first display unit 120 is executed by the interface 740 including a display device and displaying images according to the control of the CPU 710. User operations are received through the first operation input unit 130 by the interface 740 having an input device and receiving user operations.

In the case where the data generation device 200b is implemented in the computer 700, operations of the counterpart model execution unit 291b, the evaluation value calculation unit 292, and each unit thereof are stored in the auxiliary storage device 730 in the form of program. The CPU 710 reads out the program from the auxiliary storage device 730, loads it on the primary storage device 720, and executes the processes described above, according to the program.

Also, the CPU 710 reserves a storage region in the primary storage device 720 for the processing to be performed by the data generation device 200b according to the program.

Communication with other devices performed by the data generation device 200b is executed by the interface 740 having a communication function and operating under the control of the CPU 710.

Interaction between the data generation device 200b and a user is executed by the interface 740 having an input device and an output device, presenting information to the user through the output device under the control of the CPU 710, and receiving user operations through the input device.

In the case where the learning device 610 is implemented in the computer 700, operations of the history information acquisition unit 611, the evaluation value acquisition unit 612, and the learning unit 613 are stored in the form of a program in the auxiliary storage device 730. The CPU 710 reads out the program from the auxiliary storage device 730, loads it on the primary storage device 720, and executes the processes described above, according to the program.

Also, the CPU 710 reserves a storage region in the primary storage device 720 for the processing to be performed by the learning device 610, according to the program.

Communication with another device performed by the learning device 610 is executed by the interface 740 having a communication function and operating under the control of the CPU 710.

Interaction between the learning device 610 and a user is executed by the interface 740 having an input device and an output device, presenting information to the user through the output device under the control of CPU 710, and receiving user operations through the input device.

In the case where the learning device 620 is implemented in the computer 700, operations of the history information acquisition unit 621, the evaluation value acquisition unit 622, the learning unit 623, the counterpart model execution unit 624, and the evaluation unit 625 are stored in the form of a program in the auxiliary storage device 730. The CPU 710 reads out the program from the auxiliary storage device 730, loads it on the primary storage device 720, and executes the processes described above, according to the program.

Also, the CPU 710 reserves a storage region in the primary storage device 720 for the processing to be performed by the learning system 620, according to the program.

Communication with another device performed by the learning system 620 is executed by the interface 740 having a communication function and operating under the control of the CPU 710.

Interaction between the learning system 620 and a user is executed by the interface 740 having an input device and an output device, presenting information to the user through the output device under the control of CPU 710, and receiving user operations through the input device.

In the case where the proposal determination device 630 is implemented in the computer 700, operations of the history information acquisition unit 631 and the proposal output unit 632 are stored in the form of a program in the auxiliary storage device 730. The CPU 710 reads out the program from the auxiliary storage device 730, loads it on the primary storage device 720, and executes the processes described above, according to the program.

Also, the CPU 710 reserves a storage region in the primary storage device 720 for the processing to be performed by the proposal determination device 630 according to the program.

Communication with another device performed by the proposal determination device 630 is executed by the interface 740 having a communication function and operating under the control of the CPU 710.

Interaction between the proposal determination device 630 and a user is executed by the interface 740 having an input device and an output device, presenting information to the user through the output device under the control of the CPU 710, and receiving user operations through the input device.

Any one or more of the programs described above may be recorded in the non-volatile recording medium 750. In such a case, the interface 740 may read the program from the non-volatile recording medium 750. Then, the CPU 710 directly executes the program read by the interface 740, or it may be temporarily stored in the primary storage device 720 or the auxiliary storage device 730 and then executed.

It should be noted that a program for executing some or all of the processes performed by the learning device 100, the data generation device 200, the proposal determination device 400, the data generation device 200b, the learning device 610, the learning system 620, and the proposal determination device 630 may be recorded on a computer-readable recording medium, and the program recorded on the recording medium may be read into and executed on a computer system, to thereby perform the processing of each unit. The “computer system” here includes an OS (operating system) and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built in a computer system. The above program may be a program for realizing a part of the functions described above, and may be a program capable of realizing the functions described above in combination with a program already recorded in a computer system.

The example embodiments of the present invention have been described in detail with reference to the drawings. However, the specific configuration of the invention is not limited to the example embodiments, and may include designs and so forth that do not depart from the scope of the present invention.

This application is based upon and claims the benefit of priority from Japanese patent application No. 2021-141626, filed on Aug. 31, 2021, the disclosure of which is incorporated herein in its entirety.

### INDUSTRIAL APPLICABILITY

The present disclosure may be applied to a learning device, a learning system, a proposal determination device, a learning method, and a recording medium.

### DESCRIPTION OF REFERENCE SYMBOLS

1, 620 Learning system
100, 610 Learning device
110 First communication unit
120 First display unit
130 First operation input unit
180 First storage unit
190 First control unit
191 History information generation unit
192 Action determination unit
193 Learning control unit
200, 200b Data generation device
210 Second communication unit
220 Second display unit
230 Second operation input unit
280 Second storage unit
290 Second control unit
291, 291b Counterpart model execution unit
291c Proposal determination unit
291d Noise adding unit
292 Evaluation value calculation unit
300 Neural network
400, 630 Proposal determination device
611, 621, 631 History information acquisition unit
612, 622 Evaluation value acquisition unit
613, 623 Learning unit
624 Counterpart model execution unit
625 Evaluation unit
632 Proposal output unit

What is claimed is:

1. A learning device comprising:
a memory configured to store instructions; and
a processor configured to execute the instructions to:
acquire history information about a proposal which has been implemented in a negotiation;
acquire an evaluation value for a proposal from a negotiation counterpart; and
learn a determination method for an own proposal to the negotiation counterpart, based on the history information and the evaluation value.

2. The learning device according to claim 1,
wherein the processor is configured to execute the instructions to output the history information in vector format data, and
the memory stores a neural network that, upon receiving an input of the history information in the vector format data, outputs its own proposal to the negotiation counterpart.

3. A learning system comprising:
a memory configured to store instructions; and
a processor configured to execute the instructions to:
acquire history information about a proposal which has been implemented in a negotiation;
acquire an evaluation value for a proposal from a negotiation counterpart;
learn a determination method for an own proposal to the negotiation counterpart, based on the history information and the evaluation value, and output its own proposal to the negotiation counterpart based on the determination method;
output, upon receiving an input of its own proposal to the negotiation counterpart, a proposal from the negotiation counterpart; and
output, upon receiving an input of a proposal from the negotiation counterpart, the evaluation value.

4. The learning system according to claim 3, wherein the processor is configured to execute the instructions to:
determine a proposal according to an own proposal to the negotiation counterpart; and
add noise to a proposal from the negotiation counterpart determined by the proposal determination means.

5. (canceled)

6. A learning method executed by computer, comprising:
acquiring history information about a proposal which has been implemented in a negotiation;
acquiring an evaluation value for a proposal from a negotiation counterpart; and
learning a determination method for an own proposal to the negotiation counterpart, based on the history information and the evaluation value.

7. (canceled)
